(19) United States
(12) Patent Application Publication
(10) Pub. No.: US 2014/0035197 A1
(43) Pub. Date: Feb. 6, 2014

(54) PROCESS FOR MANUFACTURING AN ORNAMENTAL DESIGN MOLDED ONTO AN EARPHONE/HEADPHONE CORD

(71) Applicant: TREVOR STALEY, AGOURA HILLS, CA (US)

(72) Inventor: TREVOR STALEY, AGOURA HILLS, CA (US)

(21) Appl. No.: 14/053,894

(22) Filed: Oct. 15, 2013

Related U.S. Application Data
(63) Continuation-in-part of application No. 13/342,572, filed on Jan. 3, 2012, now abandoned.

(51) Int. Cl. B29C 45/14

(52) U.S. Cl. CPC B29C 45/14688
USPC 264/272.15

(57) ABSTRACT

A process can manufacture an ornamental design molded onto an earphone cord. The process involves the following steps. First, designing a top and bottom mold with mold earphone channels immediately adjacent to mold ornament channels. Then, boring a mold injection port into the top mold. After that, boring a material, injection channel into the bottom mold. Subsequently, inserting the earphone cord into the bottom mold earphone channel and the top mold earphone channel, Then, allowing melted material to flow from the top mold into the bottom mold and through the mold earphone channels and the mold ornament channels covering the earphone cord with material without damaging the earphone cord. Next, permitting the material to harden around the earphone cord forming a molded decorative symbol around the earphone cord. Then, removing the molded decorative symbol from the top mold and the bottom mold.

### RELATED APPLICATIONS

This application is a continuation-in-part of U.S. patent application Ser. No. 13/342,572 which is presently pending and claims priority to provisional patent application U.S. Ser. No. 61/460,425 filed on Jan. 3, 2011, the entire contents of which is herein incorporated by reference.

### BACKGROUND

The embodiments herein relate generally to processes for incorporating ornamental features onto the earphone cords that connect earphones, headphones, ear buds, and any other small loudspeakers that are used close or in the user's ear, with a listening device, such as mp3 players, cd players, radios, media players etc.

Contemporary earphones and headphones are connected to a listening device with an unadorned earphone cord. Previous devices teach that an ornament can he attached to the by using an aftermarket clip on device, However, these devices are temporary and leave open the issue of creating permanent ornaments onto earphone cords. One reason why these devices are favored is that heretofore undisclosed manufacturing processes are necessary to mold a cord to an ornament.

The Zeig U.S. Pat. App. No. 2008/0285785 A1 teaches an ornamental addition to a headphone cord that is attached by clipping the device to the cord. It does not teach an ornamental headphone cord with a permanently fixed ornament.

The Ko U.S. Pat. No. 7,715,888 B3 teaches an ornamental necklace used as a Bluetooth earphone piece. The ornament is held over the necklace with a single piece of material and is not permanently affixed to the cord.

U.S. Pat. No. 8,129,620 issued to Schorr teaches affixing an ornament to a wire with glue and teaches away from the plastic working process disclosed below.

### SUMMARY

A process for manaufacturing an ornamental design molded onto an earphone cord. The process comprises the following steps not necessarily in order. First, designing a top mold with a top mold earphone channel immediately adjacent to a top mold ornament channel. Then, designing a bottom mold with a bottom mold earphone channel immediately adjacent to a bottom mold ornament channel. After that, boring a mold injection port into the top mold. Next, boring a material injection channel into the bottom mold, Subsequently, inserting the earphone cord into the bottom mold earphone channel and the top mold earphone channel. Following that, aligning the mold injection port with the material injection channel. Then, allowing melted material to flow from the top mold into the bottom mold. After that, permitting the melted material to flow into the material injection channel and then into the bottom mold ornament channel and the top mold ornament channel. Next, covering the earphone cord with material without damaging the earphone cord. Subsequently, permitting the material to harden around the earphone cord firming a molded decorative symbol around the earphone cord. Following that, removing the molded decorative symbol from the top mold and the bottom mold.

In some embodiments, the earphone cord is double insulated, rigid and/or malleable. In some embodiments, the bottom mold earphone channel further comprises a plurality of bottom mold cavities and raised portions limiting exposure of the earphone cord to heat, In some embodiments, the top mold earphone channel further comprises a plurality of top mold cavities and raised portions limiting exposure of the earphone cord to heat.

### BRIEF DESCRIPTION OF THE FIGURES

The detailed description of some embodiments of the invention is made below with reference to the accompanying figures, wherein like numerals represent corresponding parts of the figures.

FIG. 1 is an explanatory illustration of the invention in use.

FIG. 2 is a detailed section view of the invention taken along a line 2-2 shown in FIG. 1.

FIG. 3 shows a perspective view of an embodiment of a bottom mold.

FIG. 4 shows a perspective view of an embodiment of a top mold.

FIG. 5 shows the interface of the bottom mold and the top mold.

FIG. 6 is a perspective view of an embodiment of the invention in use.

FIG. 7 is a perspective view of an embodiment of the invention in use.

FIG. 8 is a top view of an embodiment of the invention in use showing the path of the cable.

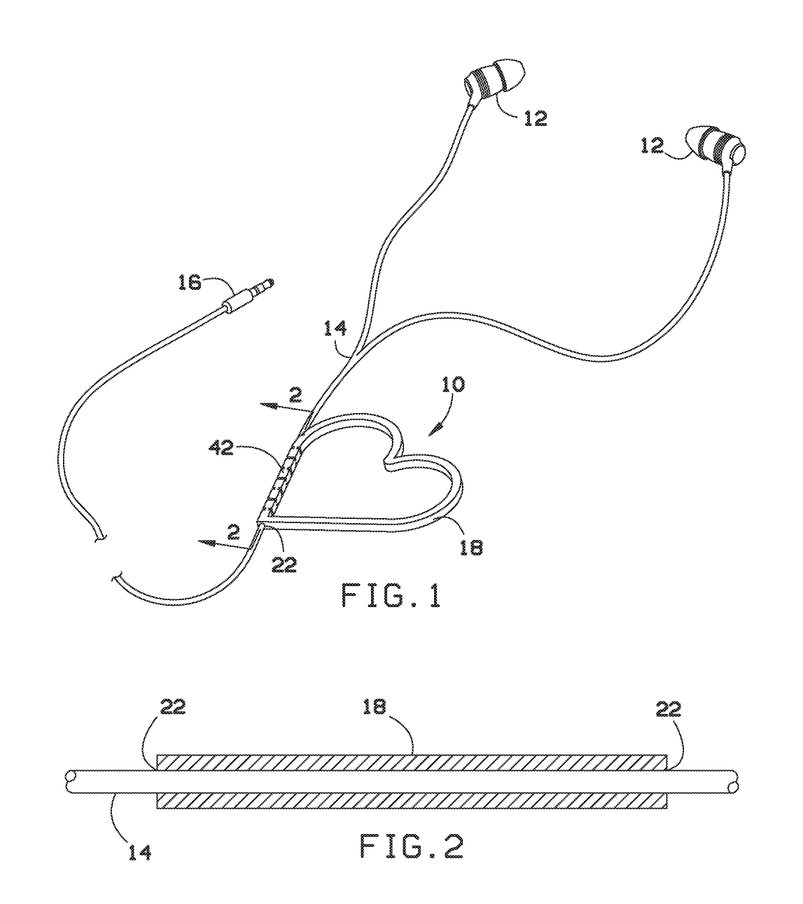

### DETAILED DESCRIPTION OF CERTAIN EMBODIMENTS

By way of example, and referring to Figure l one embodiment of headphone assembly 10 contains earphone speakers 12. Earphone speakers 12 are communicatively coupled to earphone cord 14. Earphone cord 14 is immediately adjacent to molded decorative symbol 18. Molded decorative symbol 18 contains molded opening 22 for earphone cord 14. Molded decorative symbol 18 comprises transition portion 42 which comprises a plurality of cavities such as right angle cavities that enable earphone cord 14 to he attached to molded decorative symbol 18 without damaging earphone cord 14.

Earphone cord 14 is communicatively coupled with earphone speaker 16. Earphone cord 14 contains at least two wires, a first. wire which can provide stereo sound to a first earphone speaker 16 and a second wire which provides sound to a second earphone speaker 16. Both wires are joined inside earphone cord 14. However, that need not be the case. Both wires could separately enter and exit molded decorative symbol 18 through a plurality of molded opening 22 before being joined together in a since earphone cord 14 before entering earphone speaker 16.

Turning to FIG. 2, a cross section of molded decorative symbol 18 is shown. This figure shows how earphone cord 14 is completely covered by molded decorative symbol 1$ between two points marked by molded opening 22. The plurality of molded openings shown here by the two points represent an entry point and an exit point for the earphone cord.

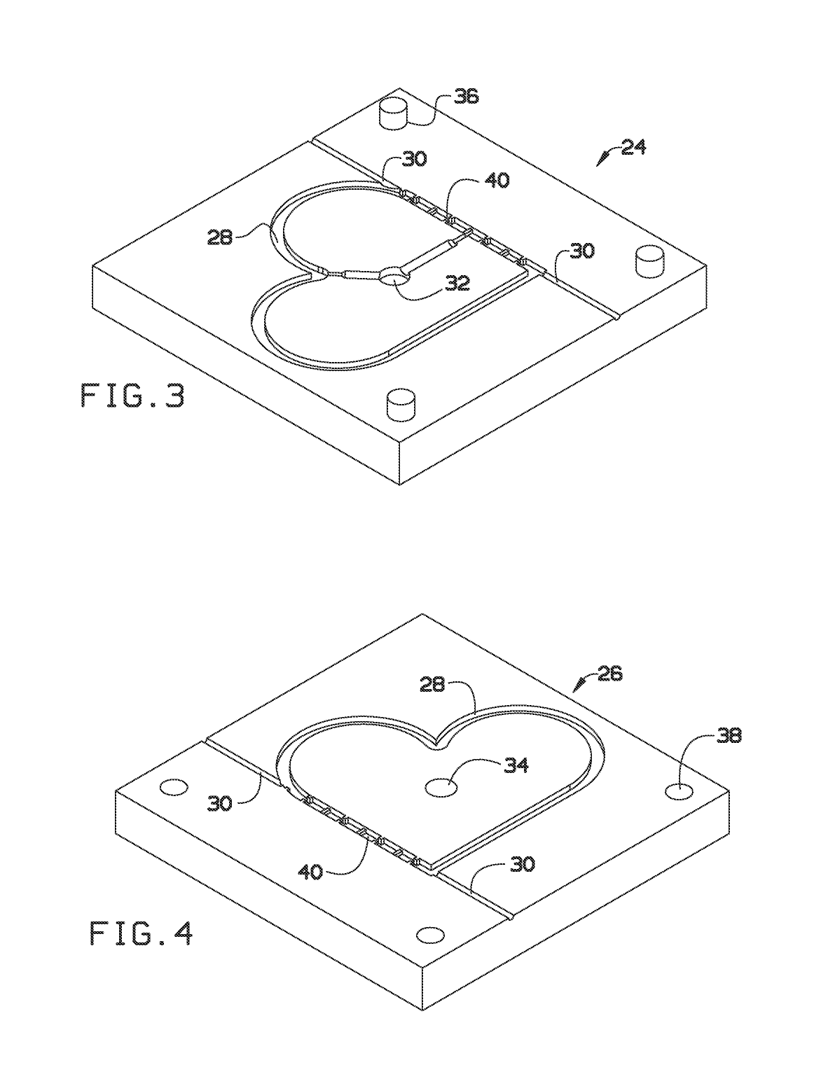

Turning to FIG. 3 and FIG. 4, bottom mold 24 comprises bottom mold earphone channel 30 immediately adjacent to bottom mold ornament channel 28. Bottom mold earphone channel 30 comprises a plurality of bottom mold cavities and raised portions 40. Bottom mold ornament channel 3$ is further connected to bottom mold earphone channel 30 by material injection channel 32. Bottom mold 24 further comprises alignment tabs 36 which can be used to align top mold 26.

Top mold 26 likewise comprises top mold earphone channel 30 immediately adjacent to top mold ornament channel 28. Top mold earphone channel 30 comprises a plurality atop mold cavities and raised portions 40 Top mold 26 is perforated with mold injection port 34 which can be used to insert material through material injection channel 33. To mold 26 further comprises alignment cavities 38 Which can be used to align top mold 26,

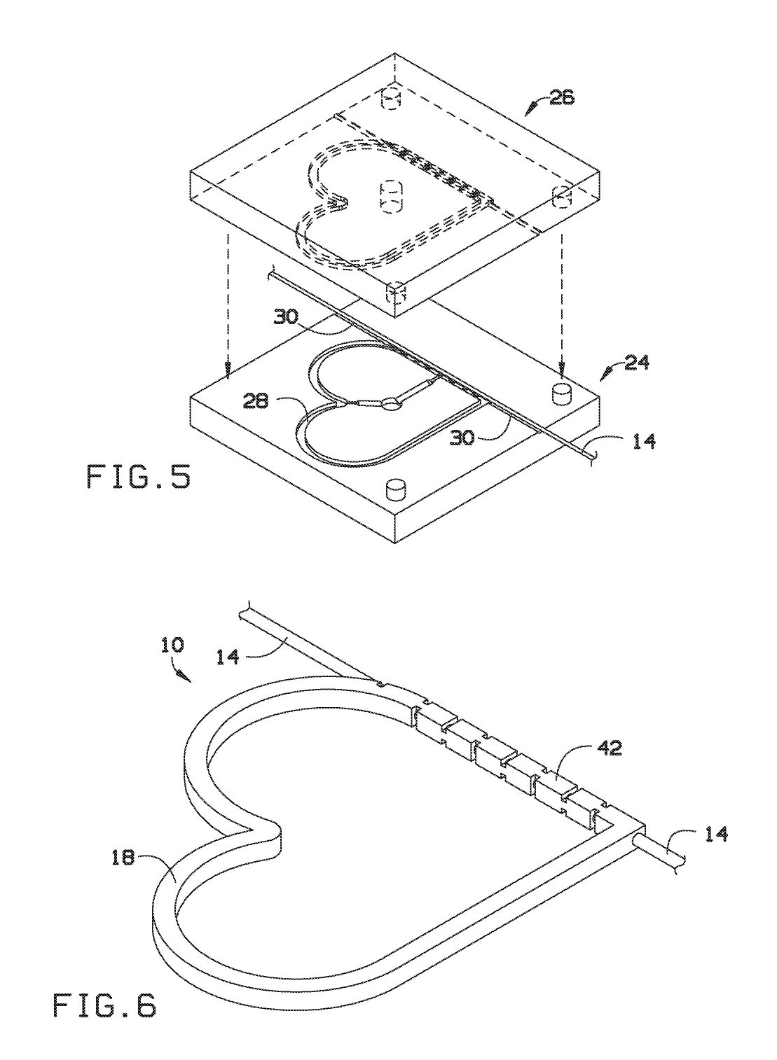

Turning to FIG. 5, a user must design top mold 26 and bottom mold 24 with a reciprocal design in each mold. Next, the user must bore mold injection port 34 into top mold 26 in order to allow melted material to flow from top mold 36 into bottom mold 24. Once in bottom mold 24, material Bows into material injection channel 32 and then into bottom mold ornament channel 28 and top mold ornament channel 28.

A portion of bottom mold ornament channel 28 comprises bottom mold earphone channel 30 which further comprises a plurality of bottom mold cavities and raised portions 40. Likewise, a portion of to mold ornament channel 2$ comprises to mold earphone channel 30 which further comprises a plurality of top mold cavities and raised portions 40.

In a significant departure from Schorr and other technology that involves making cords, there is too much heat in the material to allow forming the material around cord 14. However, cavities 42. reduce the volume of material near any point of cord 16 and thus reduces the heat that is transferred to cord 14. After the plastic hardens, molded decorative symbol is permanently fixed to earphone cord 14. Depending on the heat of the plastic it may be necessary to insure that earphone cord 14 is produced using double insulated speaker cable to prevent damage to the first wire and the second wire.

Turning to FIG. 7, an embodiment of the invention where earphone cord 14 contains molded alphanumeric characters 20. Molded alphanumeric characters 20 contains molded opening 22 fur earphone cord 14. Here, any combination from the set of alphanumeric characters can be used from the selection of A, B, C, D, E, F, G, H, I, J, K, L, M, N, O, P, Q, R, S, T, U, V, W, X, Y, Z, a, b, c, d, e, f, g, h, i, j, k, l, m, n, o, p, q, r, s, t, u, v, w, x, y, z, 1, 2, 3, 4, 5, 6, 7, 8, 9, 0.

One version of an ornament is comprised of as front side and a back side, both may be identical on either side. In addition to molded alphanumeric characters 20 the ornamental object may be shapes or hearts. One embodiment of the earphone cord 14 may be customizable by the user by manipulating the cord to a desired shape. This may allow the user to express himself or herself further.

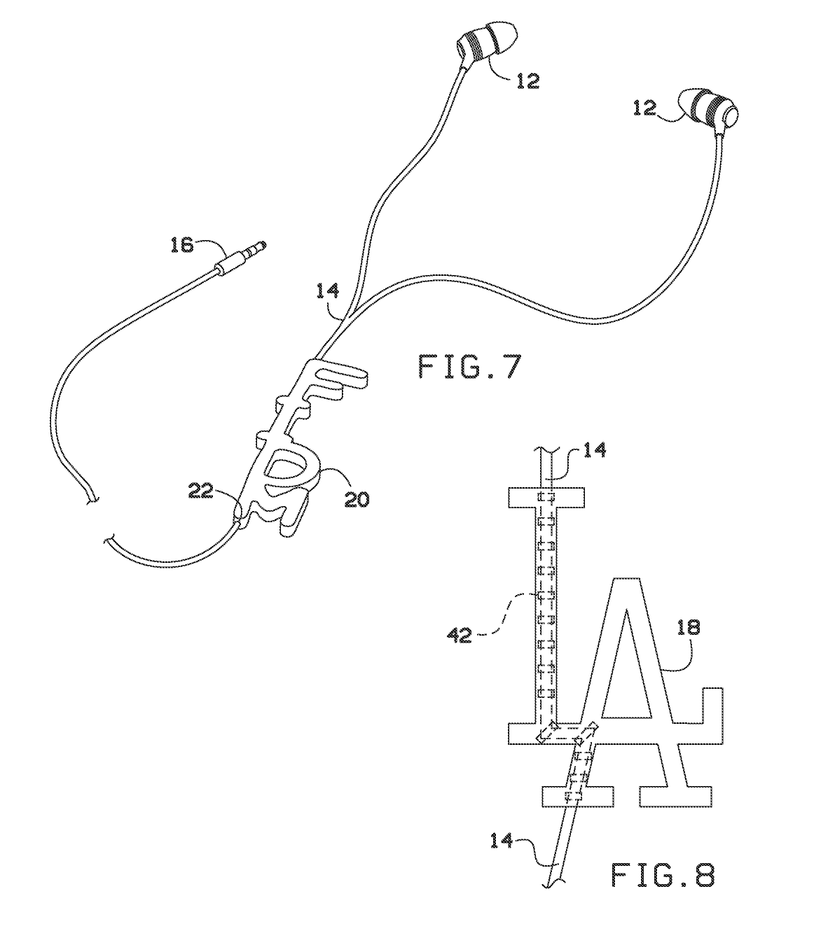

As shown in FIG. 8, regardless of the configuration chosen, the location of bottom mold earphone channel 30 and to mold earphone channel 30, should be as linear as possible and the shortest distance between a top portion of molded decorative symbol 18 and a bottom portion of molded decorative symbol 18.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A process for manufacturing an ornamental design molded onto an earphone cord;
the process comprising:
designing a top mold with a top mold earphone channel immediately adjacent to a top mold ornament channel;
designing a bottom mold with a bottom mold earphone channel immediately adjacent to a bottom mold ornament channel;
boring a mold injection port into the top mold;
boring a material injection channel into the bottom mold;
inserting the earphone cord into the bottom mold earphone channel and the top mold earphone channel;
aligning the meld injection port with the material injection channel;
allowing melted material to flow from the top mold into the bottom mold;
permitting the melted material to flow into the material injection channel and then into the bottom mold ornament channel and the top mold ornament channel;
covering the earphone cord with material without damaging the earphone cord;
permitting the material to harden around the earphone cord forming a molded decorative symbol around the earphone cord; and
removing the molded decorative symbol from the top mold and the bottom mold.

2. The process of claim 1, wherein the earphone cord is double insulated.

3. The process of claim 1, wherein the molded decorative symbol is rigid.

4. The process of claim 1, wherein the molded decorative symbol is malleable.

5. The process of claim 1, wherein the bottom mold earphone channel further comprises a plurality of bottom mold cavities and raised portions limiting exposure of the earphone cord to heat.

6. The process of claim 1, wherein the top mold earphone channel further comprises a plurality of top mold cavities and raised portions limiting exposure of the earphone cord to heat.
